(19) United States
(12) Patent Application Publication
(10) Pub. No.: US 2004/0000438 A1
(43) Pub. Date: Jan. 1, 2004

(54) Scale having a capacitive proximity switch with an electrode

(75) Inventor: Klaus Stree, Backnang (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Soehnle-Waagen GmbH & Co. KG, Murrhardt (DE)

(21) Appl. No.: 10/461,767

(22) Filed: Jun. 13, 2003

(30) Foreign Application Priority Data
Jun. 14, 2002 (DE) 102 26 770.7
Feb. 27, 2003 (DE) 103 08 804.0

(51) Int. Cl. G01G 23/32

(52) U.S. Cl. 177/178

(57) ABSTRACT

A scale is provided which includes a support plate for holding a mass to be weighed, and an electrical switch device for selecting or dialing a function of the scale. The electrical switch device has a capacitive proximity switch with an electrode disposed on the support plate. The capacitive proximity switch monitors an ambient capacitance of the electrode, and reacts solely to the approach of an object (such as a human foot) whose dielectrical properties are different from those of the stationary environment of the proximity switch.

### FIELD OF THE INVENTION

The invention relates to a scale having a support plate for holding a mass to be weighed and having a switch device for selecting or dialing a function of the scale.

### BACKGROUND OF THE INVENTION

A scale having a support plate and a switch device is known for instance in the form of an electrical personal or bathroom scale for measuring and displaying the weight of a person standing on the support plate. By means of the switch device, the scale can be switched on and off, so that the electrical energy demand of this scale can be limited purely to the measuring and displaying operation.

For tripping the switching event, some conventional scales have a contact switch, which can be actuated by the person, using one foot. The conventional contact switch, however, is complicated in terms of cabling and also requires the user to aim at an exactly defined point on the scale—namely precisely at the contact switch—in order to actuate the switch.

As an alternative to the contact switch, an acoustic switch is also known, which reacts to oscillations caused by tapping on the scale. A major disadvantage of the acoustic switch, however, is that it not only reacts to an intentional action by the user but also may react in an uncontrolled and unwanted way to extraneous noises.

Measuring systems that are constantly in operation are also known, with the aid of which the scale may be activated by way of changes in weight on the support plate. However, such measuring systems constantly draw current and thus have a high energy demand.

### OBJECT OF THE INVENTION

It is an object of the invention to provide a scale having a support plate and a switch device in which switching is easy and effected in a highly reliable manner, and which at the same time has low production and operating costs.

### SUMMARY OF THE INVENTION

A scale is provided which comprises a support plate for holding a mass to be weighed, and an electrical switch device for selecting or dialing a function of the scale, wherein the electrical switch device comprises a capacitive proximity switch and an electrode disposed on the support plate. The capacitive proximity switch monitors an ambient capacitance of the electrode, and reacts solely to the approach of an object (such as a human foot) whose dielectrical properties are different from those of the stationary environment of the proximity switch.

### BRIEF DESCRIPTION OF THE DRAWINGS

FIG. 1 shows a perspective view of a scale according to one embodiment of the invention;

FIG. 2 is a side view from the direction II shown in FIG. 1; and

FIG. 3 shows a perspective view of a scale according to another embodiment of the invention.

### DETAILED DESCRIPTION

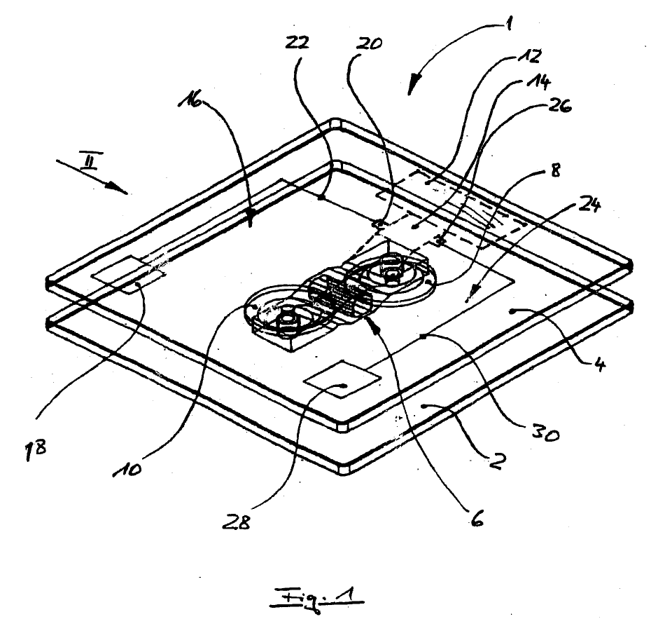

FIG. 1 shows a scale 1, embodied as a bathroom or personal scale, with a base plate 2 and a support plate 4, also known as a load plate. A weighing cell 6 is connected to the base plate 2 via a fastening plate 8 and to the support plate 4 via a fastening plate 10. The scale 1 also includes a display unit 12, and a processing unit 14 for evaluating measured values detected by the weighing cell 6 and processing the measured values for display on the display unit 12. As a result, the weight of a mass, in particular of a person, weighing down on the support plate 4 is indicated by the display unit 12.

A first electrical switch device 16 with a capacitive proximity switch is provided to turn the scale 1 on and off. The first electrical switch device 16 comprises an electrode 18 disposed on the support plate 4, an evaluation unit 20 for monitoring and evaluating the ambient capacitance of the electrode 18, and an electric lead 22 connecting the electrode 18 and the evaluation unit 20.

A second electrical switch device 24 with a capacitive proximity switch is provided in order to read out data, stored in a memory and evaluation unit 26, for instance pertaining to a weight profile of a person weighing himself with the scale 1. The second electrical switch device 24 comprises an electrode 28 on the support plate 4, and an electric lead 30 connecting the electrode 28 to the memory and evaluation unit 26.

The support plate 4, on which the electrodes 18, 28 of the capacitive proximity switches of the switch devices 16, 24 are located, may comprise an electrically nonconductive material, such as glass, plastic, or granite.

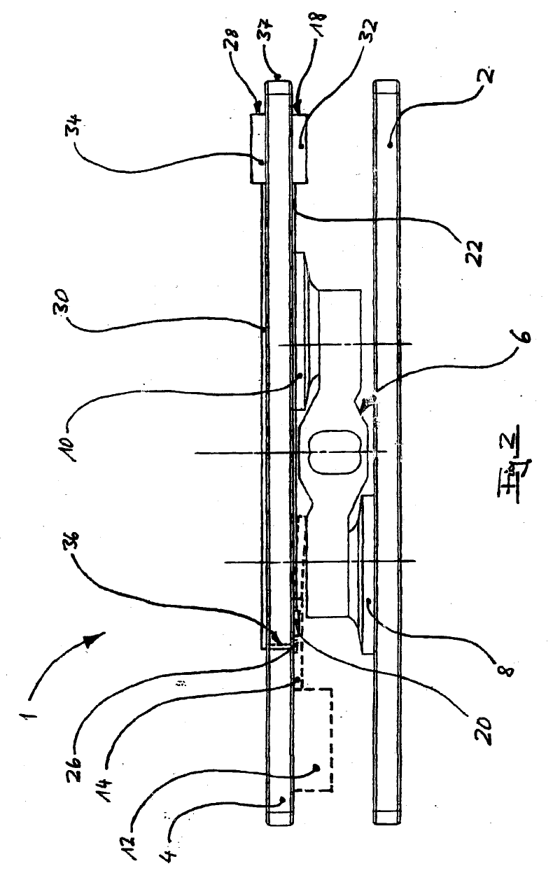

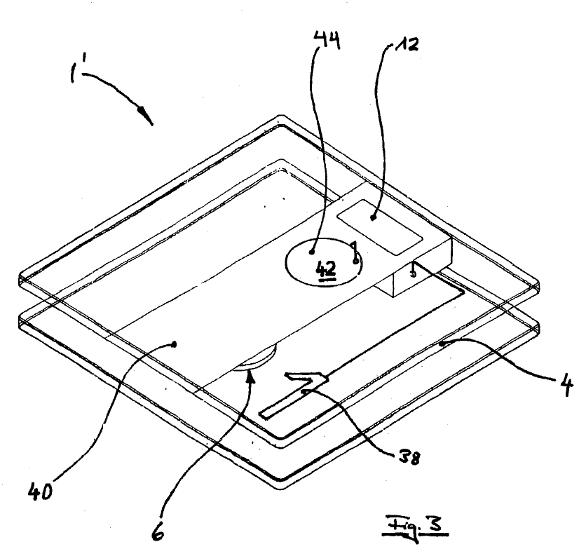

FIG. 2 shows a side view of the scale 1 of FIG. 1, with identical components in FIG. 2 (and FIG. 3) being identified with the same reference numerals.

As shown in FIG. 2, the electrode 18 of the first electrical switch device 16 may comprise an electrically conductive printed layer (or film) 32 that is provided on or under the support plate 4. The electrically conductive printed layer 32 may include an electrically conductive paint or graphite, and the electric lead 22 which connects the electrode 18 to the evaluation unit 20, can—particularly if the support plate 4 is a glass plate—be a transparent, electrically conductive layer, for instance of indium-tin oxide.

The electrode 28 of the second electrical switch device 24 may comprise a sputtered layer (or film) 34 which may, for example, be vapor deposited on or under the support plate 4. And as shown in FIG. 2, the electric lead 30 that connects the electrode 28 to the memory and evaluation unit 26 is passed through the support plate 4 by means of a leadthrough 36.

For the sake of clarity, both the electrodes 18, 28 and the electric leads 22, 30 are shown with an exaggerated layer thickness in FIG. 2. Without impairing their function, but at increased production costs, the printed layer and/or sputtered layer could also be disposed on the narrow side face 37 of the support plate 4.

FIG. 3 shows a scale 1′, also embodied as a bathroom or personal scale, according to another embodiment of the invention. This scale 1′ includes a switch device with a capacitive proximity switch that has an electrode 38 of an electrically conductive metal element glued from below to the back side of the support plate 4. The electrode 38 may, for example, be a stamped sheet-metal part in the shape of the numeral “1” which, for instance, indicates that when the capacitive proximity switch is actuated, data for a first person stored in a memory will be shown by the display unit 12. As in the case of the first embodiment, the scale 1′ shown in FIG. 3 includes a weighing cell 6. In this embodiment, the weighing cell 6 is essentially concealed by a screen (or baffle) 40, and the weighing cell 6 is secured to the support plate 4 via an intermediate element 42. The intermediate element 42 forms an electrode 44 of a capacitive proximity switch of another switch device for selecting or dialing a function of the scale 1′ such as, for example, turning the scale on. And in this embodiment, the scale 1′ may be turned off automatically after a preset time lag, within which the weighing process is usually concluded.

Significantly, the capacitive proximity switch of the present invention reacts solely to the approach of an object (such as a human foot) whose dielectrical properties are different from those of the stationary environment of the proximity switch. And in the case of a bathroom scale, it does not matter whether or not the foot is bare or clothed.

In the scale of the present invention, the ambient capacitance of the electrode(s) may be evaluated over time, and in the event of certain typical changes in the ambient capacitance of the electrode(s), a signal can be sent to downstream circuit elements. The selection or dialing of a function of the scale effected with the electric switch device can, for instance, comprise turning the scale on and optionally off. The function, moreover, can also comprise allocating or calling up memories that contain person-specific data, for instance, or previously measured values.

Significantly, the scale of the invention is especially reliable in use since there is no need to hit a switch as precisely as is required in the case of a conventional mechanical switch. And since mechanical moving parts can be dispensed with, the scale of the invention is also not subject to wear. In addition, the capacitive proximity switch of the scale of the invention requires little energy in operation, and because of its simple construction with only a few elements the scale of the invention can be mass-produced economically on a large scale. Still further, particularly with bathroom scales which are typically used in humid conditions, the fact that the device of the invention can be well protected is of major significance.

In principle, the embodiment of the electrode is unlimited. However, for simple production of the scale in a way that can be automated without major effort, it is especially advantageous if the electrode has an electrically conductive printed layer on or under the support plate. This printed layer can be applied to the surface of the support plate directly, for instance by screenprinting. For reasons of cost, it is advantageous if the printed layer includes an electrically conductive paint or graphite.

In another advantageous refinement of the invention, the electrode comprises a sputtered layer, which is electrically conductive at least in a partial region, on or under the support plate. This kind of layer sputtered onto the surface of the support plate can be made quite thin, which saves material, without impairing the operational reliability of the scale.

The number of components in the scale of the invention can be advantageously further reduced if, in another refinement of the invention, a weighing cell contacting the support plate directly or via an intermediate element is provided, and at least one weighing cell element or intermediate element in contact with the support plate forms the electrode. In an especially simple embodiment, the weighing cell that is provided in the scale for measuring weight can overall also form the electrode of the capacitive proximity switch.

For producing the scale in small numbers economically and also for manual assembly, it is suitable if the electrode comprises an electrically conductive metal element mounted on the support plate. The arbitrarily shaped metal element can for instance be glued to the support plate in a simple way and can comprise a metal foil or a stamped metal sheet.

Especially simply, and without significantly increasing the production costs, in an advantageous refinement of the invention, at least two switch devices that have a capacitive proximity switch are provided, and the switch devices are disposed in different regions of the support plate and are intended for switching different functions. For instance, one switch device can serve to switch the scale on and off, and with the other switch device, the user can read earlier measured values of the scale out of an evaluation unit. And in this case, because the switch devices are disposed in different regions of the support plate, mistakes in operation are precluded to the maximum extent.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A scale comprising:
a support plate for holding a mass to be weighed; and
an electrical switch device for selecting or dialing a function of the scale;
wherein the electrical switch device comprises a capacitive proximity switch and an electrode disposed on the support plate, and the capacitive proximity switch monitors an ambient capacitance of the electrode.

2. The scale of claim 1, wherein the electrode comprises an electrically conductive printed layer provided on or under the support plate.

3. The scale of claim 2, wherein the printed layer includes an electrically conductive paint or graphite.

4. The scale of claim 1, wherein the electrode comprises a sputtered layer provided on or under the support plate, and wherein the sputtered layer is electrically conductive in at least a partial region.

5. The scale of claim 1, further comprising a weighing cell that is coupled to the support plate either directly or via an intermediate element, and wherein at least one element of the weighing cell element or intermediate element in contact with the support plate forms the electrode.

6. The scale of claim 1, wherein the electrode comprises an electrically conductive metal element mounted on the support plate.

7. A scale comprising:
a support plate for holding a mass to be weighed; and
a first electrical switch device for selecting or dialing a first function of the scale;
a second electrical switch device for selecting or dialing a second function of the scale;
wherein each of the first and second electrical switch devices comprises a capacitive proximity switch and an electrode disposed on the support plate, and the capacitive proximity switch monitors an ambient capacitance of the electrode; and
wherein the first and second electrical switch devices are disposed in different regions of the support plate and switch different functions of the scale.
